(19) United States
(12) Patent Application Publication
(10) Pub. No.: US 2007/0106557 A1
(43) Pub. Date: May 10, 2007

(54) Advertisements with Compensation for Attention

(76) Inventor: Kivin Varghese, Research Triangle Park, NC (US)

Correspondence Address: ANDREW MCALEAVEY, 4600 ADELINE ST., #101, EMERYVILLE, CA, 94608, US

(21) Appl. No.: 11/616,461

(22) Filed: Dec. 27, 2006

Related U.S. Application Data
(63) Continuation-in-part of application No. 11/382,616, filed on May 10, 2006.
(63) Continuation-in-part of application No. 10/474,242, filed on Oct. 7, 2003.
(60) Provisional application No. 60/283,471, filed on Apr. 12, 2001.

(51) Int. Cl. G06Q 30/00

(52) U.S. Cl. 705/14

(57) ABSTRACT

Methods and systems for advertising are disclosed. In the disclosed methods, an advertisement is selectively broadcast or otherwise distributed with a compensation tag indicating that a user may receive compensation for his or her attention to the advertisements. If the user responds to the compensation tag, his or her attention to the advertisement is verified and he or she is compensated. Depending on the embodiment, the advertisement may be broadcast or distributed using television, interactive television, billboards, radio, print, cellular telephone, other mobile devices, the World Wide Web, or another medium.

### CROSS-REFERENCE TO RELATED APPLICATIONS

This application is a continuation-in-part of U.S. patent application Ser. No. 11/382,616, filed on May 10, 2006, and a continuation-in-part of U.S. patent application Ser. No. 10/474,242, filed on Oct. 7, 2003. U.S. patent application Ser. No. 10/474,242 is the National Stage of PCT/US02/11449, filed Apr. 12, 2002, which claims priority to U.S. Provisional Patent Application No. 60/283,471, filed Apr. 12, 2001. The contents of all of those applications are incorporated by reference herein in their entireties.

### BACKGROUND OF THE INVENTION

1. Field of the Invention

The invention relates to methods for advertising.

2. Description of Related Art

For many years, the advertising industry has relied on a combination of different types of advertisements, including display advertisements, audio, video, and interactive commercials. Those forms of advertisements have come to pervade popular entertainment, from print media to radio, television, movies, and the World Wide Web. However, as advertisements have become more pervasive, consumer attention to advertisements has waned.

Unfortunately, the problem of waning attention continues to grow because of advances in technology and changes in entertainment forms and habits. Digital video recorders, for example, make it ever easier to skip or fast-forward through advertisements, and a plethora of cable and satellite entertainment programming appears to have fragmented audiences and decreased the average consumer's attention span.

Marketers continue to try to find new ways to capture consumer attention, and have begun to focus on the World Wide Web and other new media outlets, including interactive TV advertising. However, advertising on the World Wide Web and in other new forms of media is still emerging. For example, conventional banner, flash, and video advertising on the World Wide Web is ubiquitous but its efficacy is unproven.

### SUMMARY OF THE INVENTION

One aspect of the invention pertains to a method of advertising. The method comprises selectively providing an advertisement with a compensation tag indicating that compensation is available in exchange for attention to the advertisement in accordance with one or more decision rules. For each user who responds to the compensation tag, the method further comprises confirming that the user has paid attention to the advertisement and providing the user with compensation.

Other aspects, features, and advantages of the invention will be described below.

### BRIEF DESCRIPTION OF THE DRAWINGS

The invention will be described with respect to the following drawing figures, in which like numerals represent like elements throughout the figures, and in which:

FIG. 1 is an illustration of a World Wide Web page with a banner advertisement including a compensation tag, according to one embodiment of the invention;

FIG. 2 is a flow diagram of a method in accordance with an embodiment of the invention;

FIG. 3 is a flow diagram illustrating the continuation of certain tasks in the method of FIG. 2;

FIG. 4 is a diagram of a system for distributing advertisements according to an embodiment of the invention;

FIG. 5 is an illustration of an exemplary report that an advertiser might be presented with to summarize the results of an advertising campaign in the system of FIG. 4;

FIG. 6 is a diagram of a system for distributing advertisements with compensation tags using mobile devices according to another embodiment of the invention;

FIG. 7 is a diagram of a system for distributing advertisements with compensation tags using interactive television using yet another embodiment of the invention;

FIG. 8 is an illustration of an advertisement with a compensation tag as displayed on interactive television; and

FIG. 9 is an illustration of a full screen compensation tag used if a user is fast-forwarding through an advertisement that includes a compensation tag.

### DETAILED DESCRIPTION

U.S. patent application Ser. No. 10/474,242, of which this application is a continuation-in-part, discloses methods and systems of advertising. Using the methods and systems of that application, a consumer is presented with the opportunity to earn credit in exchange for viewing one or more advertisements. Generally, after viewing the advertisement, the user is asked to answer one or more questions related to the advertisement. Additionally, before viewing an advertisement, a user may be asked one or more questions to gauge brand and other behaviors. The credit offered to the user in exchange for viewing the advertisement may be monetary or may be some other form of credit having value to the user.

In using those methods to view advertisements and earn credit, the user is asked to create an account with the operator of the method. The user then views advertisements, answers questions, and collects credit, typically using a World Wide Web-based interface.

As disclosed in that application, compensation need not be offered exclusively in connection with advertisements offered by the operator of a pay-for-attention method and viewed exclusively through an interface provided by that operator. Instead, as disclosed both in U.S. patent application Ser. No. 10/474,242 and also in U.S. patent application Ser. No. 11/382,616, pay-for-attention methods may be used to increase the efficacy of advertising in all media, including World Wide Web-based media; conventional broadcast media, such as print, radio, and television; interactive media, such as interactive television; and other media, including that presented on cellular telephones, personal digital assistants (PDAs) and other mobile devices. Generally speaking, an advertisement, in whatever form, may be presented along with a compensation tag, indicating that compensation is available to the user who takes further action.

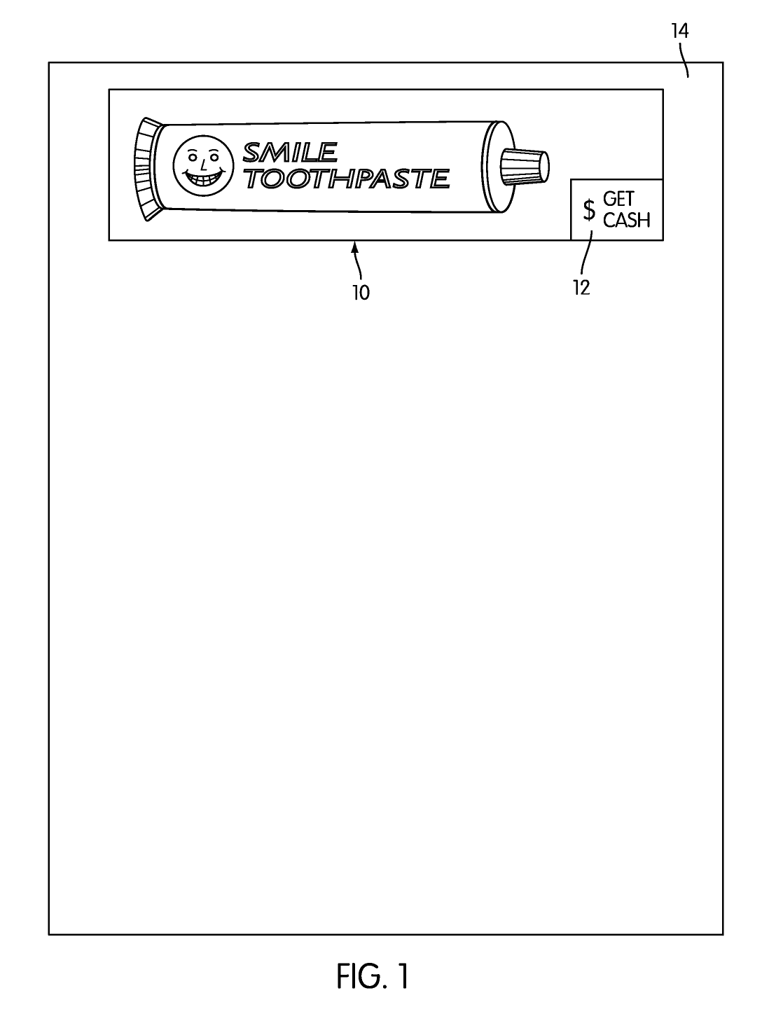

FIG. 1 is an illustration of an advertisement, generally indicated at 10, with a compensation tag 12. The advertisement 10 in the illustrated embodiment is in the form of a banner advertisement on a web page 14 of the World Wide Web, although the advertisement 10 may be presented in other forms and in other media in other embodiments of the invention. Embodiments in which an advertisement like advertisement 10 is placed in other media will be described below in more detail.

As the term is used here, “advertisement” refers to any sort of presentation intended to inform the user of a particular product or service or to influence or gauge user attitudes, perceptions, or behavior in some way. Examples of advertisements include product advertisements, service advertisements, political advertisements, and informational pages with data, imagery, or other information about the product/service. Advertisements may be presented in different formats. Examples of advertisement formats include videos, static display ads, billboards, spoken word and musical advertisements, animations, and interactive games, questionnaires, and presentations.

In the context of the web page 14, the advertisement 10 serves to inform the viewer of a product or service. As with conventional banner advertisements, the advertisement 10 may or may not relate to the content of the remainder of the web page 14. It may be a static banner advertisement, or it may include animation, sound, or other media. From a technical standpoint, the advertisement 10 may have any file format or features that are compatible with conventional World Wide Web browsing software and/or other technology used to view and interact with the web page 14. Although the advertisement 10 may be placed by and maintained by the same party that offers the web page 14, in some embodiments, the placement of advertisements 10 will be handled by a third party. Systems for managing the distribution of advertisements 10 will be described below.

Many different considerations come into play when deciding which particular advertisement 10 or advertisements 10 are displayed on any one web page 14, and any of those considerations may be taken into account in embodiments of the embodiments. Exemplary advertisement placement considerations that may be taken into account include the nature and subject matter of the web site of which the web page 14 is a part, the demographics of the users who are likely to view the web page 14, the overall number of users who are likely to see the advertisement 10 on the particular web page 14, and the advertising rates set by the owner and operator of the web site.

As was noted above, the advertisement 10 includes a compensation tag 12. The term “compensation tag,” as used in this description, refers to any visual, textual, or auditory indication that compensation is available in exchange for paying attention to the advertisement 10. The tag 12 may be a simple graphical icon, a graphical icon combined with text, spoken words or audio, a set of musical notes, a set of graphical or textual instructions for receiving the compensation, or any combination of the above. Moreover, although shown as a part of the advertisement 10 in FIG. 1, the compensation tag 12 may be presented before the advertisement 10, after the advertisement 10, in a different space than the advertisement 10, or in any other manner, provided that a user is able to discern that the compensation tag 12 is associated with the advertisement 10.

In effect, the compensation tag 12 serves as an advertisement within an advertisement, in that it advertises the availability of compensation. Generally, when a user clicks on the advertisement 10, or otherwise follows the steps indicated by the compensation tag 12 (if the compensation tag 12 indicates steps to be taken) he or she will be asked to confirm that he or she has paid attention to the advertisement, typically by answering some number of questions correctly. Of course, in exchange for compensation, the user may be asked any type of question, including questions about a user's life, demographic attributes, and buying or brand behaviors. This will be described below in more detail.

Generally speaking, it is advantageous if compensation tags 12 take the same overall form across multiple advertisements 10 and multiple media, so that users begin to associate the presence of a specific type or form of compensation tag 12 with a specific company or brand. However, the form, style, or content of compensation tags 12 may be varied as needed for marketing or other reasons.

Compensation tags, such as tag 12, may be selectively placed on advertisements. That is, not every advertisement like advertisement 10 will necessarily have a compensation tag 12. Whether or not an advertisement 10 carries a compensation tag 12 may depend on any or all of the same considerations listed above that apply to the placement of the advertisement 10 itself, and methods for determining when an advertisement 10 should carry a compensation tag 12 will be described in greater detail below.

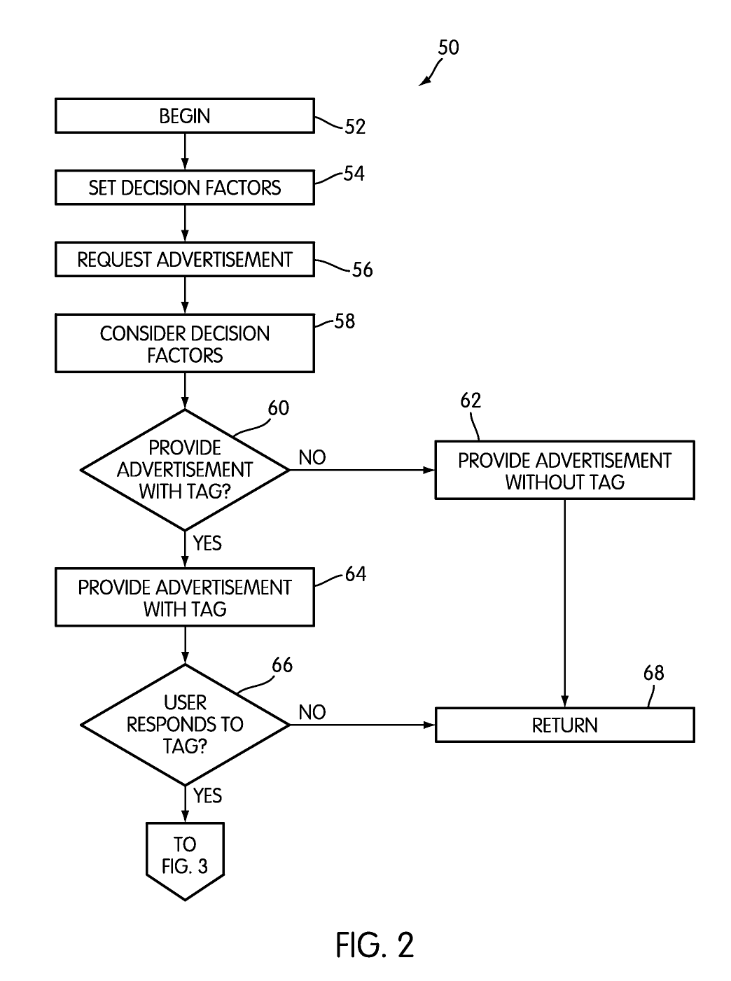

FIG. 2 is a flow diagram of a method, generally indicated at 50, for advertising and providing compensation in connection with the advertising. Method 50 begins at task 52 and continues with task 54. For ease of explanation, method 50 of FIG. 2 generally continues the example set forth above of a compensation tag 12 on a web-based advertisement 10, although the method is generally applicable to any of the types of media listed above. Certain adaptations for more conventional media will be described below.

In task 54, decision factors are set to establish the conditions under which an advertisement 10 with a compensation tag 12 will be provided. The decision factors may be any of the considerations described above.

In order to understand the function of decision factors, it is helpful to understand the typical financial arrangements that might be made between an advertiser and the parties responsible for distributing its advertisements. As one example, assume a major advertiser wishes to purchase a block of advertising on a website. Under conventional arrangements, the advertiser might pay for a certain number of “impressions” or “page views.” For example, the advertiser might pay $10,000 for 1,000,000 impressions of a particular advertisement 10. Some advertisers also pay an additional amount of money for users who actually click on or otherwise pursue the advertisement. In embodiments of the present invention, the advertiser might also designate a certain amount of money, for example, $1,000, as an “incentive budget” to be used to compensate users for their attention. Thus, embodiments of the present invention may be used to augment the traditional advertisement sales schemes.

If an advertiser makes an incentive budget available, the advertiser might pay a certain amount every time an advertisement 10 with a compensation tag 12 is shown, a slightly higher amount if a user responds to the compensation tag 12, and an even higher amount if the user responds to the compensation tag 12 and is then able to verify that he or she paid attention to the advertisement 10. This pricing structure could be expanded to other user actions as well. For example, the advertiser might pay or compensate more if the user is asked for and chooses to provide a response to or specific comments on the advertisement 10.

In an embodiment like that set forth above, the advertiser and/or the third party compensation coordinator are generally interested in seeing that the incentive budget provided to handle user compensation for attention is not exceeded. Therefore, one of the decision factors of task 54 may be whether or not the budget provided for user compensation for a particular advertisement 10 has been exceeded.

Other decision factors could include the nature of the web page 14 or other medium on which the advertisement 10 is to be displayed or heard, the known or assumed demographic attributes of the users viewing the web page 14 or other medium, and other factors regarding the nature of the web page 14 or other medium and the nature of the users viewing that web page 14 or other medium. Arbitrary decision factors may also be set. For example, it could be decided that an advertisement 10 with a compensation tag 12 is to be provided every third time the advertisement 10 is requested, or it could be decided that an advertisement 10 with a compensation tag 12 is to be provided randomly. Additionally, decision factors could be set such that the advertisement 10 with the compensation tag 12 would be geographically targeted only to users in a certain country, state, city, or neighborhood.

In this description, task 54, in which the decision factors are set, is performed after method 50 begins. However, in other embodiments, the decision factors that dictate when an advertisement 10 with a compensation tag 12 is to be provided may be set or revised at any time before, during, or after the execution of method 50.

Method 50 continues with task 56, in which an advertisement 10 is requested. In the context of the Internet and World Wide Web, when a user requests a web page 14, hypertext markup language (HTML) or other code is sent from a web server that hosts the web page 14 to a browser program running on a user's computing device. The computing device may be a personal or laptop computer, a personal digital assistant (PDA), a web-enabled cellular phone, a television set-top box, or some other device capable of running software. In an example where the interface is a World Wide Web browser, the code sent to the user's browser defines the layout of the web page 14 and generally also instructs the browser to contact additional web servers to retrieve images that define the content of the web page 14 and images that relate to the advertisements 10. For example, the HTML code that defines a particular web page 14 may instruct a browser to obtain an advertisement image from a third-party provider of advertisements 10. Generally, the HTML code is written in such a way that when the browser contacts the servers of the third-party advertising provider, the web page 14 for which the advertisement is being requested is identified. The HTML code that defines the web page 14 is typically written in such a way that if a user clicks on the advertisement 10, the resulting events are often determined by the third-party advertisement distributor, or alternately by the owner of the web page 14 if the owner serves advertisements from its own servers.

The manner in which an advertisement 10 is requested in task 56 is generally known in the art and is transparent to the user. In most cases, the user would simply load a web page 14 in which he or she is interested and would receive a number of advertisements 10 with that web page 14. This is actually a particular advantage of method 50—in method 50, advertisements 10 with compensation tags 12 are provided to the user in a manner compatible with existing technologies, without the user having to perform any special action.

Once the request for an advertisement 10 has been made, method 50 continues with task 58. In task 58, the party responsible for providing the advertisement 10, such as the third-party advertisement distributor described above, reviews the request for an advertisement 10 and considers the decision factors set in task 54 as well as any other available information. As was described above, for example, the advertisement distributor would generally be aware of the web page 14 on which the advertisement is to appear, and may also be aware of some or all of the attributes of the user. For example, an advertisement distributor may have stored a “cookie” in the user's browser. “Cookies,” as is known in the art, are small amounts of descriptive or user tracking information that are stored in a user's browser and that can be requested and read by the web server that placed them.

Ultimately, method 50 continues with task 60, a decision task, in which the decision of whether or not to provide an advertisement 10 with a compensation tag 12 is made. If, for example, the budget for user compensation has been exceeded for a particular advertisement 10, or if the user or requesting web page 14 does not meet the appropriate demographic criteria, then an advertisement 10 without a compensation tag 12 is provided in task 62 before method 50 terminates and returns at task 68. If it is decided in task 60 to provide an advertisement 10 with a compensation tag 12 (task 60: YES), an advertisement 10 with a compensation tag 12 is provided in task 64.

One of the advantages of interactive media, like the World Wide Web, is that advertisement placement is highly selective: different advertising decisions can be made each time that an opportunity for advertising arises, so that different users may see entirely different advertisements. For conventional, broadcast, such as print, radio, and television, that level of selectivity is not always possible. If user-by-user decisions are not possible in a particular medium, then tasks 54-60 of method 50 would generally be performed by examining the nature of each possible advertisement placement before that placement is made and deciding whether that advertisement should include a compensation tag 12.

However, in most media, it is possible to provide compensation tags 12 with reasonable selectivity. For example, with a conventional cable or television distribution system, different commercials may be offered at different times of day, with commercials offered at particular times of day including compensation tags 12. Different commercials may be provided in different local areas, using well-known technology for including local programming in a national feed. Similarly, radio announcers can read or play one version of an advertisement without a compensation tag 12 at one time of day and another form of an advertisement with a compensation tag 12 at another time of day. Even in the case of print and display media, selectivity is possible. For example, one version of a print advertisement in a magazine may be distributed to one country or region with a compensation tag 12 and another version of the advertisement without the compensation tag 12 may be distributed to another country or region. Additionally, mechanical billboards may display one version of an advertisement with a compensation tag 12 for a particular length of time and then rotate or change to displaying a version of an advertisement without a compensation tag 12 for some length of time.

Once an advertisement 10 with a compensation tag 12 is provided, a user may respond to the compensation tag 12 at any point. In the context of a web page such as web page 14, responding to an advertisement 10 or compensation tag 12 usually means clicking on the advertisement 10 to follow the World Wide Web link that it provides. However, what constitutes a “response” to an advertisement 10 or compensation tag 12 may differ from medium to medium, and further examples of “responses” in different media will be provided below. Method 50 continues with task 66, a decision task, in which it is determined whether a user has responded to the advertisement 10 with the compensation tag 12. If the user does respond (task 66: YES), the actions that are taken will be described below with respect to method 100. If the user does not respond (task 66: NO), method 50 terminates at task 68.

If a user does respond to an advertisement, four general tasks would typically be performed: (1) identifying the user and confirming that the user is eligible for compensation; (2) optionally presenting any additional advertising related to the advertisement 10; (3) confirming that the user has paid attention to the advertising by asking questions or by some other means of confirmation; and (4) awarding compensation to the user.

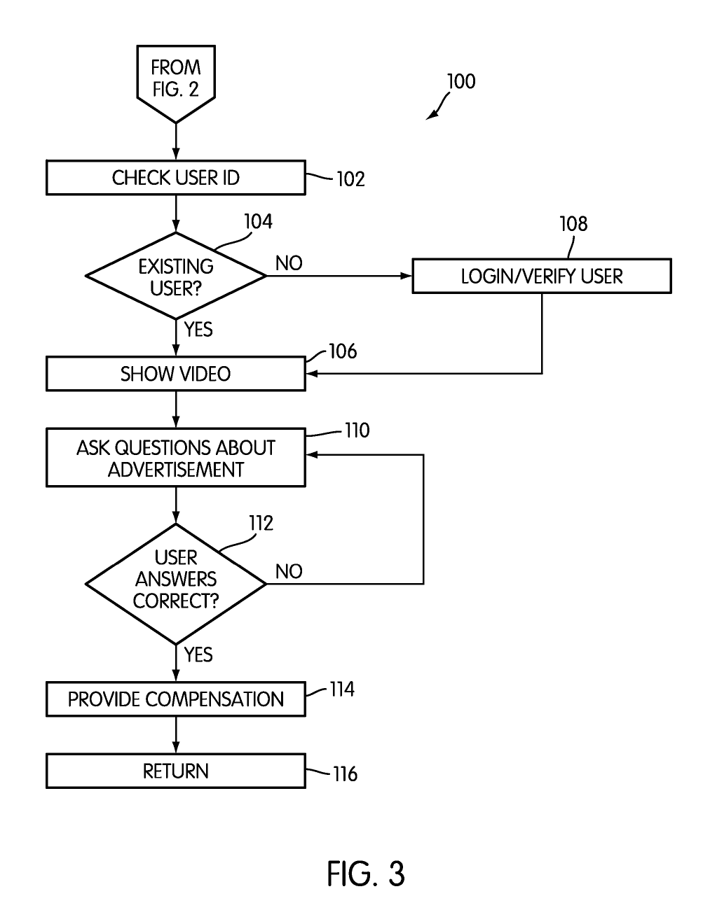

FIG. 3 illustrates a method 100 of performing those general tasks. Method 100 begins when a user responds to a compensation tag 12 in task 66 of method 50 and continues with task 102.

In task 102, it is determined whether or not the user who responded to the compensation tag 12 is already known to the third-party advertisement distributor and/or the provider of compensation. As is disclosed in U.S. patent application Ser. No. 11/382,616, of which this application is a continuation-in-part, users of a pay-for-attention service generally create accounts with the provider of the service. Those accounts generally include at least information on the user's identity, methods by which the user may be contacted, and bank account or other compensation delivery information.

One way in which a user may be identified as a returning or known user of method 100 is by checking the user's browser for any cookies that identify the user as a recurring user. Once a user identifies him- or herself, his or her identifying information may be stored in a cookie on his or her browser so that he or she can be quickly identified when he or she returns for another visit. If no cookies are present, the user may be asked to log into the service.

Task 104 is a decision task. If the user is identified as an existing user (task 104: YES), then method 100 continues with task 106. If the user is not an existing user (task 106: NO), then method 100 continues with task 108.

In task 108, the user establishes an account, and his or her identity is verified to the degree deemed necessary. The process of establishing an account may include the same general steps described in U.S. patent application Ser. No. 11/382,616; that is, the user would be asked to fill out a questionnaire that included at least his or her name and e-mail address and, if desired by the operator of the method, questions relating to the user's demographic, psychographic, and behavioral traits and information. Demographic information includes location and vital statistics. Psychographic information refers to information that tends to indicate the social class and lifestyle of a user. Behavioral information refers to information on specific behaviors, such as spending, shopping, visiting, and/or website browsing behaviors and activity. The user might be asked any number of questions that the operator of method 100 desires; however, the number of questions asked of the new user and the range of information collected at the outset would generally be balanced against the possibility of alienating the user and driving him or her away. Some questions that the user is asked when establishing a new account may be designated as “required” while other questions may be designated as “optional.”

When and if the user is directed to a site to establish an account, that site may be a privately branded site. That is, the site to which the user is directed may overtly belong to a third party compensation coordinator and be advertised as such, or the site may appear to be sponsored or created by the party or brand to whom or to which the advertisement pertains. For example, if the user was offered an advertisement having to do with a particular brand of toothpaste, the web site on which the user establishes an account may appear to be created or maintained by that brand or the company that sells the brand. If the site is branded with a particular brand, it may be maintained under the aegis of the company that sells the brand or by a third party that is unaffiliated with the brand.

Whenever a user provides information to create an account, there is always the possibility that a user could be making up information, using an automated system to establish a large number of accounts, or otherwise attempting to abuse the method. Therefore, in some embodiments, users may be screened at the outset based on their contact information. For example, users may only be permitted to register and establish a new account in task 108 if they live in a particular place, have an e-mail address from a particular domain, such as the “.edu” domain, have a cellular telephone number, or are able to verify their identity or personal characteristics (e.g., gender and age) in some other way. If the user provides a cellular telephone number, for example, a text message with a password or necessary confirmation number could be sent to that number in order to verify that the user exists. Certain other conventional technologies may also be used to screen users at the outset. For example, a user could be asked to take a CAPTCHA™ (Completely Automated Public Turing Test to Tell Computers and Humans Apart) to confirm that the user is a real person. Users might also be asked to agree to terms of service or a privacy policy.

The need to verify that the user is a real person entitled to the compensation that is being offered may vary with the nature of the compensation itself. Compensation, as the term is used in this specification, refers to anything of value offered to the user in exchange for the user's attention. The types of compensation offered to the user may vary with the particular embodiment of the invention, with the desires and budget of the marketer, and with certain other factors, such as the length of the advertisement and the desirability and past behaviors or profile of the user. Generally speaking, two types of compensation may be used in any combination in method 10 and in other methods according to embodiments of the invention: monetary compensation and promotional compensation.

The term monetary compensation generally refers to negotiable currency or its equivalent in electronic form, denominated in U.S. dollars or in the currency of another country or currency-issuing authority (other examples of currency include Canadian and Australian dollars, British pounds, Euros, and Japanese Yen, to name a few). The term promotional compensation refers to other forms of compensation, which are usually tied to a particular product or service. Forms of promotional compensation may include product discounts, coupons, incentives, sweepstakes entries, free products, free content (television shows, music, video clips, articles, etc.), reduced bills for services, charitable donations made on behalf of the user, and “bonus points” or other credits that are redeemable through a particular vendor or vendors.

If the compensation being offered is promotional in nature—a discount coupon or a sweepstakes entry, for example—then there may be less of a need to verify the identity and eligibility of the user than if the compensation is monetary in nature.

Once the user's identity is established and an account is started, method 100 continues with task 106, an optional task. In task 106, a user may be shown a video or other form of advertisement to augment what they have already seen in the original advertisement 10, they may be asked brand behavior or lifestyle questions, or they may be asked any other questions or shown any other presentation that the operator of the method or the advertiser deems useful. The questions and tasks asked of the user may or may not directly relate to the advertisement 10 in question. For example, to continue with the example of a toothpaste advertisement 10 mentioned above, the user could be asked what brand of toothpaste he or she currently uses, could be shown a full-length video advertisement for the toothpaste that is the subject of the original advertisement 10, or could be asked about habits that are related, like how often the user flosses his or her teeth. Task 106 may be particularly useful, for example, when the advertiser has more to say than can be expressed in a banner or print advertisement 10.

Method 100 continues with task 110. In task 110, the user is typically asked a number of questions that relate to the advertisement 10 and, optionally, to the materials that he or she was shown in task 106, if any. The answers that the user gives to these questions are recorded and, in task 112, the answers are checked against the correct answers. If the user has provided one or more correct answers (task 112: YES), then method 100 continues with task 114 and the user is provided with compensation in accordance with the number of questions that were answered correctly. If the user did not answer the questions correctly (task 112: NO), then method 100 may return to task 110 such that the user is given another chance to answer the questions correctly. Generally speaking, the questions asked of the user should be specific enough to confirm that the user was paying attention while being straightforward enough so as to be answered by a broad swath of users without difficulty.

The amount of compensation provided to the user may vary with the number of questions the user answered correctly versus the total number that were asked. The amount of compensation may also be increased in accordance with other factors. For example, if the user was asked to answer a number of questions relating to lifestyle or behavior earlier in method 100, that may be taken into account in awarding proportionally more compensation. Additionally, if the advertisement 10 in question is in limited release or its effectiveness is being researched, the user could be asked a proportionally larger number of “focus group” type questions about the advertisement 10 and could be provided with an accordingly larger amount of compensation for time spent answering those questions. Additionally, as is described in U.S. patent application Ser. No. 11/382,616, the amount of compensation offered in connection with an advertisement may be selected by or for each individual user.

Additionally, a question asked need not relate directly to the advertisement 10 that is currently at issue. Presumably, the user will view many advertisements 10 with compensation tags 12. Therefore, in order to assess brand identification, message retention, and other factors, some of the questions that the user is asked may relate to advertisements 10 that he or she saw in the past. Questions on past advertisements may be asked at any stage after the user responds to the compensation tag.

Of course, in the context of method 100, a “question” does not have to be a conventional question. Rather, a question may be any prompt that requires a response by the user. U.S. patent application Ser. No. 11/382,616 provides several examples of prompts that are used in lieu of ordinary questions in order to confirm attention. As described in that application, a user may purchase a product or perform some other action favorable to a particular advertiser and may, in exchange, be given a receipt that includes a printed compensation tag 12 with a code. In lieu of answering some or all questions in task 110, the user may simply be prompted to enter his or her code. Compensation tags 12 with particular response codes may be attached to substantially any form of advertisement.

As illustrated in FIG. 3, method 100 terminates and returns at task 116, after compensation has been awarded. However, method 100 may include other optional tasks. For example, before method 100 terminates, the user could be offered an additional incentive that relates to the advertisement 10. For example, the user could be offered a coupon for the toothpaste in question, or for an associated product.

Method 100 presents World Wide Web-based media as an example. In other embodiments, advertisements 10 with compensation tags 12 may be presented in any medium, and the actions required of the user in order to obtain compensation may be substantially any. The user may even view or listen to the advertisement in one medium and then respond to the compensation tag 12 to obtain compensation using another medium. For example, an advertisement could be presented on television with a compensation tag 12 that indicates that if a user text messages a particular alphanumeric sequence to a particular number using Simple Message Service (SMS) on his or her cellular telephone, he or she may obtain compensation. The alphanumeric sequence may be the answer to a question posed in or as part of the compensation tag 12. In that case, the compensation might take the form of credit on the user's cellular telephone bill. Similarly, an advertisement on the radio, on television, or in print, may instruct the user to send an e-mail with particular contents to a particular address. That e-mail may include the answers to questions posed in the medium of the advertisement 10. Depending on the type of advertising campaign and the wishes of the advertiser, the user's response need not necessarily come immediately after the original advertisement 10 is presented; instead, a user may respond some time later.

In some embodiments, when a user responds to a compensation tag 12 and logs in to a Web-based service, he or she may also be provided with a list of other advertisements to view in exchange for compensation, as disclosed in this application's parent applications. Additionally, after a user has responded to a compensation tag, the advertisement associated with that compensation tag 12 may be made available and may remain available to the user for viewing or sharing over the World Wide Web, interactive television, or another medium, so that the user can view the advertisement multiple times and/or encourage others to do so. For example, a user may be offered the opportunity to “save” an advertisement 10 to a “favorites” page, may be permitted to embed the advertisement in a blog or web page, may save it to a mobile device, may e-mail the advertisement or a link to it, or forward it to others in some other way. However, compensation may be reduced or eliminated with second or subsequent viewings, at least for a user who has already received compensation.

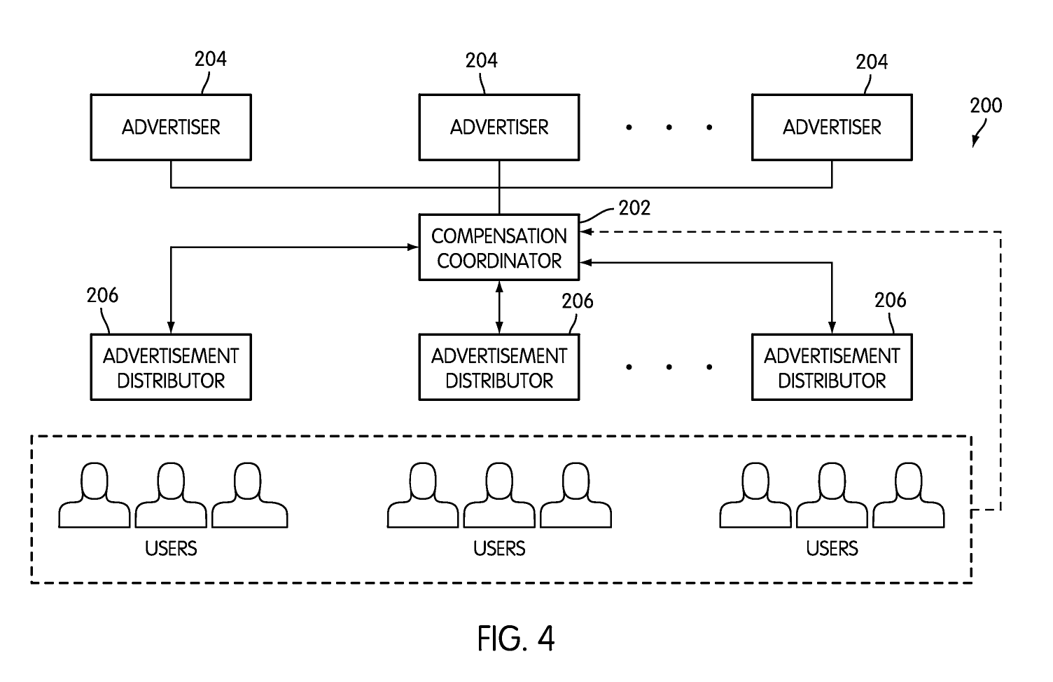

FIG. 4 is an illustration of a system, generally indicated at 200, that may be used to execute the methods described above. At the center of system 200 is a compensation coordinator 202. The compensation coordinator 202 maintains records on users, incentives, advertisements, and budgets, administers questions, and generally executes the tasks of the methods 50, 100 described above. These functions may be performed overtly in the name of the compensation coordinator 202, or they may be performed as part of a privately branded site or service.

Interacting with the compensation coordinator 202 are a number of advertisers 204. Advertisers 204 may be companies or agencies that seek to have their advertisements reach consumers. Each advertiser 204 typically seeks to reach a target population of users with specific characteristics. The advertisers 204 engage the services of the compensation coordinator 202 to provide advertisements to their target populations of users with offers of compensation in exchange for attention to their advertisements.

Advertisements 10 that are paid for and produced under the aegis of the advertisers 204 are then distributed through the various media so that they reach users. In some embodiments, the compensation coordinator 202 may act to distribute the advertisements 10 itself. However, as shown in FIG. 4, system 200 may include a number of advertisement distributors 206 that offer advertising space to advertisers. The advertisement distributors 206 may be media outlets, such as newspapers, radio and television stations and cable companies, they may be aggregators who buy advertising space in one or more media outlets and then resell that space, or they may be conglomerates who have responsibility for multiple media outlets. (Although indicated with the same reference numeral for ease of description, the individual advertisement distributors 206 may differ substantially in their markets, types of media served, and other characteristics.)

When working with advertisement distributors 206, the compensation coordinator 202 may provide advertisements 10 with and without compensation tags 12 to the advertisement distributors 206 along with explicit instructions on when to include the compensation tag 12, based on the results of a method such as method 50. Alternately, the compensation coordinator 202 may ask the advertisement distributors 206 to handle some of the tasks of method 50 and decide when a compensation tag 12 should be displayed, depending on their technical capabilities and the business model involved.

As was described above, one of the decision factors that may come into play when deciding whether or not to present a compensation tag 12 is whether or not the incentive budget connected with the advertisement 10 has been exceeded. With World Wide Web-based advertising, it is relatively simple to manage that budget on a nearly continuous manner. Before each advertisement is presented to each user, it is a relatively simple matter to check the current status of the incentive budget, either by contacting the automated systems of the compensation coordinator 202 itself or by checking the records of the advertising distributor 206 to see whether the budget provided by the compensation coordinator 202 to the advertising distributor 206 has been exceeded. This may also be the case with some other forms of interactive media, such as advertising on cellular telephones and interactive television. In those cases, it is thus relatively easy to ensure that a user who responds to a compensation tag 12 will find that compensation is actually available in connection with that compensation tag 12.

However, with some types of media, like conventional print, radio, and television advertising, it would generally be more difficult to check to see whether a sufficient incentive budget exists before presenting the advertisement 10 every time. Therefore, there exists the potential that a user who responds to the compensation tag 12 will find that the compensation is no longer available.

In systems and methods according to embodiments of the invention, there are several methods for ensuring that a user who responds to a compensation tag 12 will receive at least some compensation or incentive of value. First, the compensation tag 12 could be turned into a contest by advertising, either as a part of the compensation tag 12 or separately, that only a certain number of users who respond to the compensation tag 12 (often, the ones who respond first) will receive compensation. For example, it could be advertised that the first 100 users to respond to the compensation tag 12 will receive compensation. Incentives or compensation could be increased appropriately if the number of compensation tags 12 is relatively limited.

The method described above has the advantage that the “contest” nature of the compensation tag 12 may provide additional incentive to respond. However, there also exists the possibility that the user who responds to several compensation tags and does not receive compensation could become disillusioned and cease responding. Therefore, in most embodiments, it is beneficial if every user receives at least some form of compensation sufficient to entice them to continue responding to compensation tags. That compensation may be in the form of promotional compensation. For example, a user may be given a coupon for the product that was the subject of an advertisement, or may be entered in a sweepstakes.

Promotional types of compensation may be useful to offer users in situations where an incentive budget has been exhausted. However, the compensation coordinator 202 in system 200 has the option of offering any sort of compensation to the users and bearing the necessary costs to do so. At the option of the compensation coordinator 202, and consistent with the desires of the advertisers 204, incentives from various different advertising campaigns may be pooled to provide greater or more varied compensation.

Ultimately, the compensation coordinator 202 is responsible for accepting the advertisements 10 from the advertisers 204 and providing those advertisements 10 to the users. Typically, because of the nature of system 200, the compensation coordinator 202 is also able to provide the advertisers 204 with feedback. In embodiments of the invention, any information gathered in the course of methods such as method 50 and in the use of systems such as system 200 may be shared with the advertisers 204 in some form. The information shared with advertisers 204 may be information that is directly gathered, such as the number of users who responded to a given compensation tag 12, the amounts and types of compensation given, and the percentage of users who responded to the compensation tag 12 as compared with the total known or estimated number of users who were exposed to the advertisement 10 with the compensation tag 12. Information would likely also be reported about the users, either individually or as an aggregate, including the demographic, sociographic, psychographic, and behavioral characteristics of the users who responded to the compensation tag 12, to the extent that those characteristics are known.

Depending on the questions asked of the user during the process, the compensation coordinator 202 may also be able to gauge and report more abstract types of metrics, including the likeability of the advertisement, the purchase intent of the users who viewed the advertisement, the level of user recall of the particular advertisement, and the degree to which a message is associated with a particular advertiser.

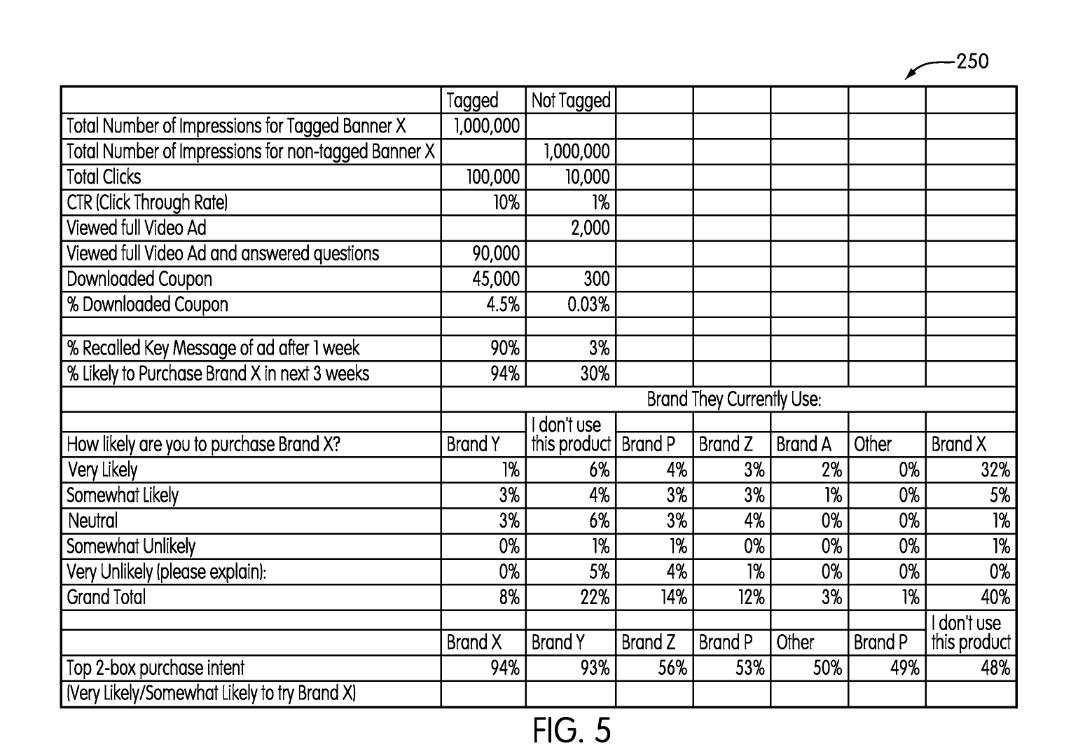

The advertisers 204 may interface with the compensation coordinator 202 through an automated system controlled by the compensation coordinator 202 that allows an advertiser 204 to log in and view information such as the status of the advertising campaign, the degree to which the advertising and incentive budgets have been used, and any of the information or metrics described above. FIG. 5 is an illustration of an exemplary report 250 for an advertising campaign including the use of compensation tags. As shown FIG. 5, report 250 illustrates basic metrics, like the total number of impressions for the tagged versus non-tagged advertisement, the total number of clicks (user responses to the advertisement), and the click-through rate (number of users who responded divided by the total number of impressions). In addition to those basic metrics, the report 250 includes data on how many of the users viewed associated video advertisements and downloaded associated coupons. Moreover, the report 250 includes information on the current brand buying habits of the users, on the brand-buying intent of the users, and on the degree to which the message of the advertisement 10 is retained as time passes.

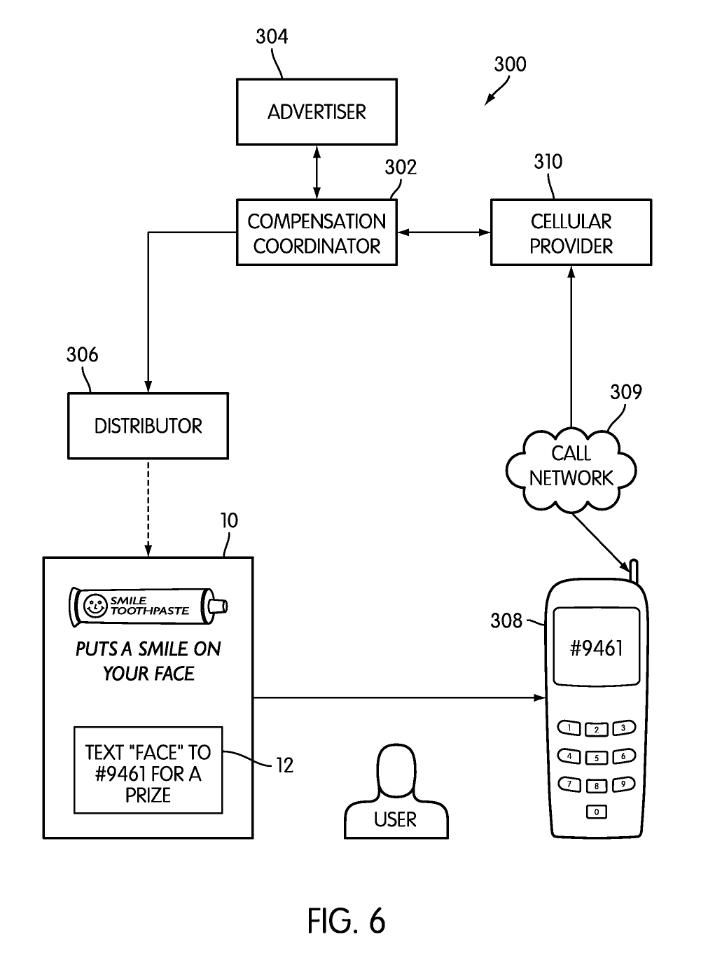

Most advantageously, because system 200 is capable of offering advertisements 10 with compensation tags 12 in substantially any medium, system 200 can be adapted to function in whichever medium is most viewed by users. As one example, FIG. 6 is an illustration of a system 300 that is similar to system 200, but is adapted for use with cellular telephones and text messaging.

In system 300, a compensation coordinator 302 again accepts advertisements 10 from one or more advertisers 304 (only one advertiser is shown in the figure for ease of illustration) and sees that those advertisements 10 are distributed through an advertisement distributor 306 with compensation tags 12 as appropriate. However, as illustrated in FIG. 6, the advertisements contain, for example, an instruction to text message a specific keyword or sequence to a specific addressee using the user's cellular telephone 308 in exchange for compensation (“Text ‘face’ to #9461 for a prize” as shown in the figure). The cellular provider 310 receives the message through the cellular network 309 and attends to transmitting it to the proper recipient, which in the case of system 300 is the compensation coordinator 302.

When that text message is received, several things may happen, depending on the embodiment, the advertiser 304, and the type of compensation that is being offered, among other factors. If, for example, the advertiser 304 is the cellular provider 310 or is under the control of the cellular provider 310, the cellular provider 310 may provide the compensation directly, for example, in the form of credits on the user's cellular telephone bill. Even in that scenario, however, the cellular provider 310 may retain the compensation coordinator 302 to track the progress of the campaign, handle the distribution of the advertisements 10, and provide whatever monitoring is desired.

If the advertiser 304 is other than the cellular provider 310, the sequence of events may be much like that described above with respect to method 50. For example, the compensation coordinator 302 may respond by sending the user a series of questions via text message and awaiting the replies. However, some tasks may be different, owing to the slightly different nature of the cellular telephone medium.

Whereas the Internet is an identity-independent medium in which it is sometimes difficult to verify the identity of an individual, cellular telephone numbers are often associated with a great deal of personal identifying information, including name, address, and often other information. Therefore, in some embodiments, the compensation coordinator 302 may be able to use the user's cellular telephone number and/or the information associated with the user's cellular telephone account to establish the user's identity, rather than asking that user to log in to a particular website and provide identifying information.

As those of skill in the art will realize, in addition to the above, cellular telephones may be used in a variety of ways in embodiments of the invention. For example, since many cellular telephones are equipped with World Wide Web browsing capability, a user may respond to a compensation tag 12 in any medium using a cellular telephone to access the World Wide Web. Additionally, a user may be given advertisements to view on his or her cellular telephone and then may be asked to respond to a compensation tag 12 using another medium. Moreover, the system shown in FIG. 6 and described above is generally applicable to many sorts of mobile devices, including PDAs. In some cases a mobile device may be equipped with a GPS device which can allow tagged ads to be served based on a user's current location (in addition to or instead of using a user's other profile information).

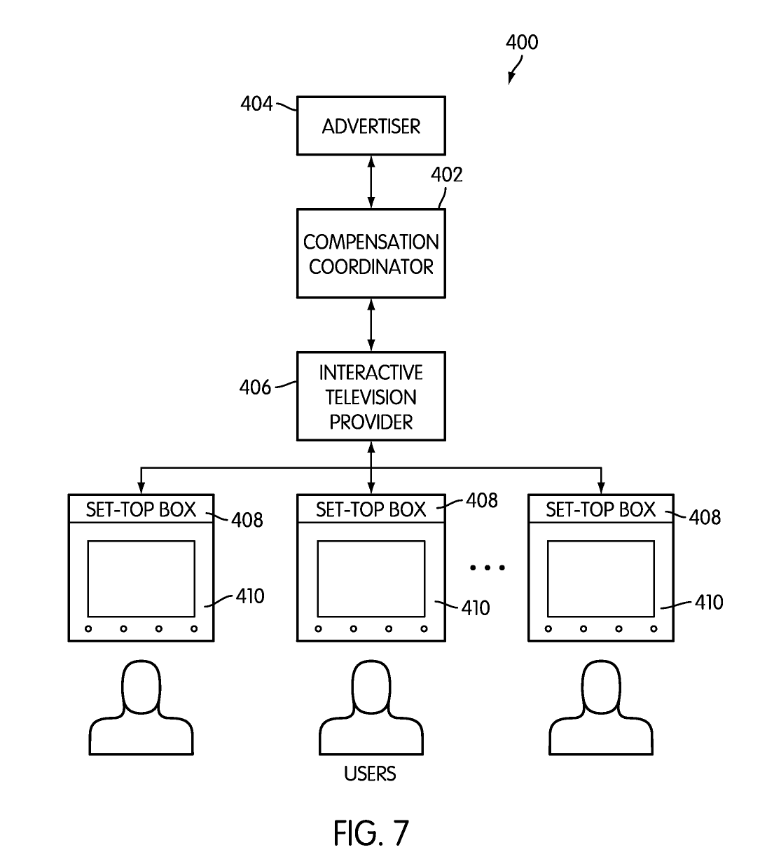

Another medium in which compensation tags 12 may be used is interactive television. FIG. 7 illustrates a system, generally illustrated at 400, that includes the use of compensation tags 12 in advertisements 10 presented using interactive television. System 400 is similar to systems 200 and 300 in that a compensation coordinator 402 accepts advertisements and has a relationship with one or more advertisers 404 (only one advertiser 404 is shown in FIG. 7, although any number may participate in system 400). Advertisements 10 are distributed selectively with compensation tags 12 by the interactive television provider 406. The interactive television provider 406 may be a cable television provider, a satellite television provider, or another entity that distributes interactive television programming.

The interactive television provider 406 interacts directly with and commands a number of set-top boxes 408, each of which is connected to a television 410 belonging to a user. Of course, as those of skill in the art will realize, the term “set-top box” is a convenience of description; the interactive television functionality may be incorporated into the television itself in some cases. Additionally, the television programming may be broadcast using a device that is not a television in the conventional sense; for example, interactive television programming may be broadcast using another multimedia device, such as a computer, as a receiver.

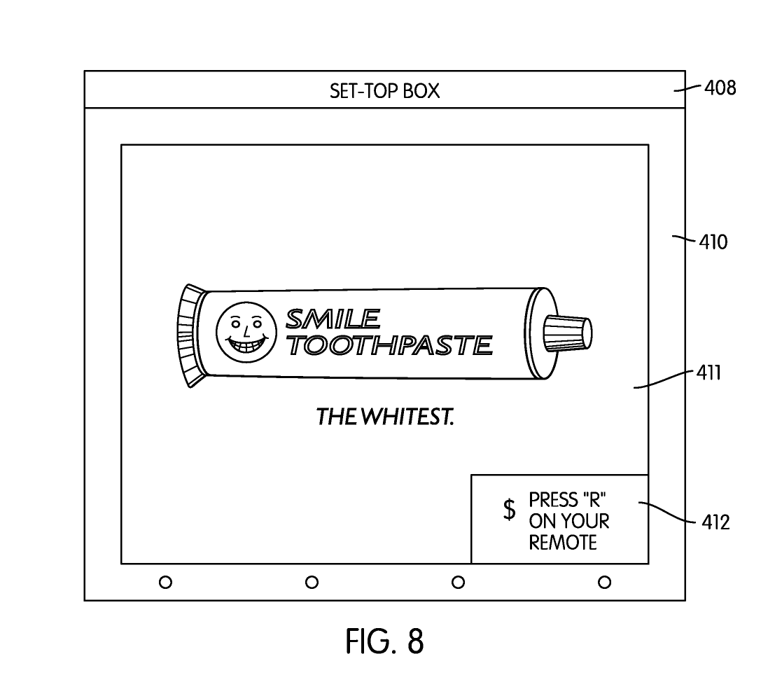

A user viewing interactive television may view and interact with advertisements that have compensation tags in a variety of ways. FIG. 8 is an illustration of an exemplary advertisement 411 playing on a television 410 with a set-top box 408. The advertisement 411 includes a compensation tag 412. The compensation tag 412 is much like the other compensation tags 12 shown and described above; in particular, it indicates the availability of compensation. As illustrated in FIG. 8, compensation tag 412 instructs the user to push a specific button on his or her remote control in order to respond to the compensation tag 412. Thus, the compensation tag 412 takes full advantage of the nature of the medium. Of course, in some embodiments, the compensation tag 412 may instruct the user to respond to the compensation tag 412 using some other medium; for example, by using a cellular phone to send a text message, or by logging onto a particular World Wide Web site.

Because of the bi-directional communication modes normally used in interactive television, the decision of whether or not to include a compensation tag 412 and the general flow of decisions follows method 50; in particular, the choice of whether or not to include a compensation tag 412 may be highly selective and based on the characteristics of the actual viewer.

In the medium of interactive television, one concern of advertisers has been the ability of digital video recorders to allow customers to automatically fast forward through or entirely skip commercials. If users do that, they are not exposed to the advertisements, and advertising dollars may be wasted.

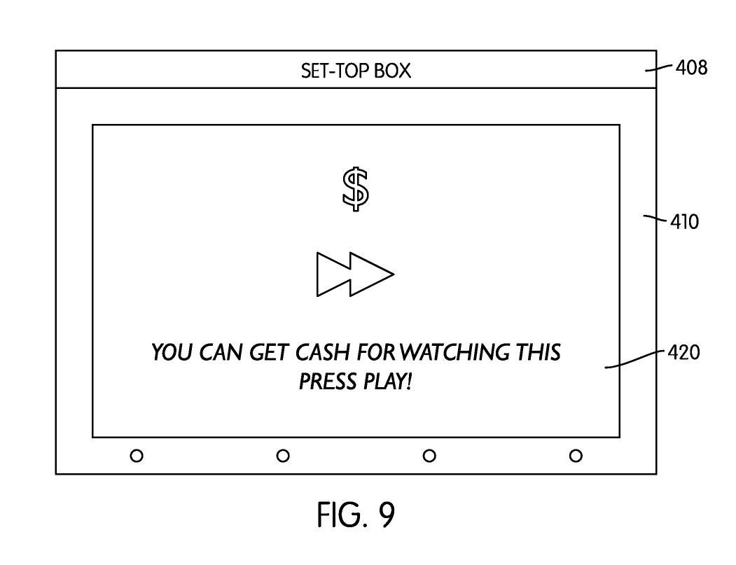

In methods and systems according to embodiments of the invention, the compensation tag 412 may be an electronic tag in addition to a visual one. For example, an electronic tag could be included in the header information for an image or video advertisement, or hidden within the image or video content itself. The fact that the advertisement 411 in question included a compensation tag 412 would be noted by the set-top box and, if the user tried to fast forward through that advertisement 411, he or she would be notified that the advertisement was tagged and that he or she would be compensated for watching it. FIG. 9 illustrates an exemplary notification screen 420 that tells the user that they can be compensated for watching what they are currently fast-forwarding through.

Because interactive television allows programming to be time-shifted, in some embodiments, users may also be presented with an interactive menu of all available advertisements 411 with compensation tags 412 and may be allowed to view those advertisements and receive compensation at their leisure.

In general, if time-shifting is permitted and the user is allowed to select from a menu of advertisements 411 with compensation tags 412, then methods of allowing a user to select an attention price in exchange for his or her attention or of selecting an attention price for that particular user may be employed, as described in U.S. patent application Ser. No. 11/382,616. That is particularly the case when the medium is one in which the identity of the user is readily established, as is the case with interactive television and cellular telephone service.

Although the invention has been described with respect to certain embodiments, those embodiments are intended to be exemplary, rather than limiting. Modifications and changes may be made within the scope of the invention, which is defined by the claims.

What is claimed is:

1. A method of advertising, comprising:
selectively providing an advertisement with a compensation tag indicating that compensation is available in exchange for attention to the advertisement in accordance with one or more decision rules; and
for each user who responds to the compensation tag:
confirming that the user has paid attention to the advertisement, and
providing the user with compensation.

2. The method of claim 1, wherein selectively providing the advertisement comprises broadcasting the advertisement in at least one medium.

3. The method of claim 1, wherein the at least one medium is selected from the group of media consisting of the World Wide Web, print, radio, television, interactive television, and mobile device.

4. The method of claim 1, wherein the compensation is monetary compensation.

5. The method of claim 1, wherein the compensation is promotional compensation.

6. The method of claim 1, wherein selectively providing the advertisement comprises:
comparing characteristics of an intended audience for the advertisement with one or more of the demographic, psychographic, or behavioral characteristics of a user or a group of users; and
providing the advertisement with a compensation tag if the characteristics of the user or the group of users compare favorably with the characteristics of the intended audience.

7. The method of claim 6, further comprising checking to see whether an incentive budget has been exceeded, and if the incentive budget has been exceeded, providing the advertisement without the compensation tag.

8. The method of claim 6, further comprising checking to see whether an incentive budget has been exceeded, and if the incentive budget has been exceeded, providing an alternate form of compensation for each user who responds to the compensation tag.

9. The method of claim 1, wherein confirming that the user has paid attention to the advertisement comprises asking the user a number of questions about the advertisement and checking at least some of the answers to those questions.

10. The method of claim 8, wherein the amount of compensation offered to the user is proportional to the number of questions that the user answers correctly.
